(19) United States
(12) Patent Application Publication
(10) Pub. No.: US 2002/0143753 A1
(43) Pub. Date: Oct. 3, 2002

(54) Product information retrieval system, product information providing terminal equipment, and product information providing method

(75) Inventor: Tatsuya Kawase, Tokyo (JP)

Correspondence Address: MCDERMOTT WILL & EMERY, 600 13TH STREET, N.W., WASHINGTON, DC, 20005-3096, US

(73) Assignee: Mitsubishi Denki Kabushiki Kaisha

(21) Appl. No.: 10/003,521

(22) Filed: Dec. 6, 2001

(30) Foreign Application Priority Data
Mar. 30, 2001 (JP) 2001-100874

(51) Int. Cl. G06F 7/00

(52) U.S. Cl. 707/3

(57) ABSTRACT

A product information retrieval system is disclosed which has a product information providing terminal and a product information requesting terminal connected via a network. The product information providing terminal includes: a product information database creating element for creating a product information database using product information received from a plurality of manufacturers; a product information retrieving element for retrieving information on products from the product information database in accordance with a search condition received from the product information requesting terminal; and a product information transmitting element for transmitting the retrieved product information to the product information requesting terminal.

### BACKGROUND OF THE INVENTION

1. Field of the Invention

The present invention relates to a product information retrieval system and, more particularly, is suitable for a system for transmitting and receiving retrieved information over a network such as the Internet.

2. Background Art

The galloping development of information technology (IT) in recent years has been accompanied by the increasingly widespread presence of the Internet. While immense quantities of information are available over the Internet, the importance of how to search for necessary information quickly through the massive volumes of netbased data is becoming apparent.

FIG. 20 is a schematic view of a conventional Internet search system. An Internet search site builds and manages a database 29 using a search host server 28 that classifies site data 31 managed by site management servers 30 located on the Internet. In its structure, the database 29 associates the sites with keywords 32 or the like in a way dependent on the search host server 28. Illustratively, one type of Internet search sites including “Yahoo” run by Yahoo Japan Corporation builds the database 29 by collecting site information from Internet site administrators; another type such as the Internet search site “Goo” operated by NTT-X Inc. builds the database 29 using a search host server 28 that automatically searches for and retrieves site data 31 over the Internet.

How a searching party 11 illustratively searches for product information is explained below by referring to a flowchart of FIG. 21. The search host server 28 acquires from the searching party 11 a search condition 12 about a given product. The server 28 compares the search condition 12 with the keywords in the database 29. Any subsequently matched sites 33 are presented as search results 14 to the searching party 11 via a terminal 13 as shown in FIG. 22 (in this example, the search condition dictates that a product A be included; the search results indicate XX hits, of which five sites are currently displayed). If the search results are not deemed satisfactory, another search condition 12 is submitted and the process is repeated until a desired site or sites are obtained.

When searches are made conventionally for information about products, the results are given merely as site names (i.e., URL information) as depicted in FIG. 22; there is no way of avoiding the chores of individually checking the retrieved sites in order to obtain detailed product information. Where the database 29 in use has been built by an automatic search type host server 28, simple matches between the keywords and the words and/or phrases included in texts such as articles at irrelevant sites can also be interpreted as hits and output as search results. Such spurious results of search have often hampered the efforts to retrieve relevant information about products.

### SUMMARY OF THE INVENTION

It is therefore an object of the present invention to overcome the above and other deficiencies of the related art and to provide means and steps to search for and retrieve information about products in a highly efficient manner using a suitable network.

It is another object of the present invention to provide means and steps allowing manufacturers and retailers to provide searching parties with desired product and sales information in an efficient manner.

According to one aspect of the present invention, a product information retrieval system comprises a product information providing terminal and a product information requesting terminal connected via a network. The product information providing terminal includes product information database creating means for creating a product information database using received product information, product information retrieving means for retrieving information on applicable products from the product information database in accordance with a search condition received from the product information requesting terminal, and product information transmitting means for transmitting the retrieved product information to the product information requesting terminal.

According to another aspect of the present invention, product information providing terminal equipment connected to a product information requesting terminal via a network. The providing terminal equipment comprises product information database creating means for creating a product information database using received product information, product information retrieving means which, in accordance with a search condition received from the product information requesting terminal, retrieves information on applicable products from the product information database, and product information transmitting means for transmitting the retrieved product information to the product information requesting terminal.

According to another aspect of the present invention, a product information providing method for use with a product information retrieval system comprising a product information providing terminal and a product information requesting terminal connected via a network. The method comprises the following steps. Firstly the product information providing terminal is allowed to receive a search condition regarding products. Secondly the product information providing terminal is allowed to retrieve information on the products applicable to the search condition from a product information database made up of product information from a plurality of manufacturers. Thirdly the product information providing terminal is allowed to transmit the retrieved product information to the product information requesting terminal.

The present invention involves creating a product information database by use of received product information and allowing information on relevant products to be retrieved from the database in accordance with a search condition received from a product information requesting terminal. This eliminates the need for any searching party to find the websites (URLs) of manufacturers and check the sites individually for product information. The embodiment allows the searching party to search for the necessary product information quickly and accurately.

Other and further objects, features and advantages of the invention will appear more fully from the following description.

### BRIEF DESCRIPTION OF THE DRAWINGS

FIG. 1 is a schematic view showing a typical structure of a product information retrieval system practiced as a common basis for embodiments of this invention;

FIG. 2 is a schematic view indicating a typical structure of a product category database;

FIG. 3 is a schematic view depicting a typical structure of a product information database;

FIG. 4 is a schematic view illustrating a typical structure of a sales information database;

FIG. 5 is a block diagram of a search host server;

FIG. 6 is a flowchart of steps constituting a procedure performed by the search host server as a first embodiment of this invention;

FIG. 7 is a schematic view of a product search menu screen applicable to the first embodiment;

FIG. 8 is a schematic view of a search result display screen applicable to the first embodiment;

FIG. 9 is a flowchart of steps constituting a procedure performed by a search host server as a second embodiment of this invention;

FIG. 10 is a schematic view of a product category search screen applicable to the second embodiment;

FIG. 11 is a schematic view of another product category search screen applicable to the second embodiment;

FIG. 12 is a schematic view of a product data display format selection screen applicable to the second embodiment;

FIG. 13 is a schematic view of a product data comparison result display screen applicable to the second embodiment;

FIG. 14 is a schematic view of a display reformat screen applicable to the second embodiment;

FIG. 15 is a schematic view of a reformatted product data comparison result display screen applicable to the second embodiment;

FIG. 16 is a flowchart of steps constituting a procedure performed by a search host server as a third embodiment of this invention;

FIG. 17 is a schematic view of a sales data display format selection screen applicable to the third embodiment;

FIG. 18 is a schematic view of a sales data comparison result display screen applicable to the third embodiment;

FIG. 19 is a schematic view of a reformatted sales data comparison result display screen applicable to the third embodiment;

FIG. 20 is a schematic view representing a typical structure of a conventional Internet search system;

FIG. 21 is a flowchart of steps constituting a procedure carried out by a search host server of the conventional Internet search system; and

FIG. 22 is a schematic view showing typical results of a search carried out by the conventional Internet search system.

### DETAILED DESCRIPTION OF THE PREFERRED EMBODIMENTS

First Embodiment

The first embodiment of this invention is discussed below by referring to the accompanying drawings. A product retrieval system that is common to the different embodiments to be described below will be explained first, followed by a description of the first embodiment.

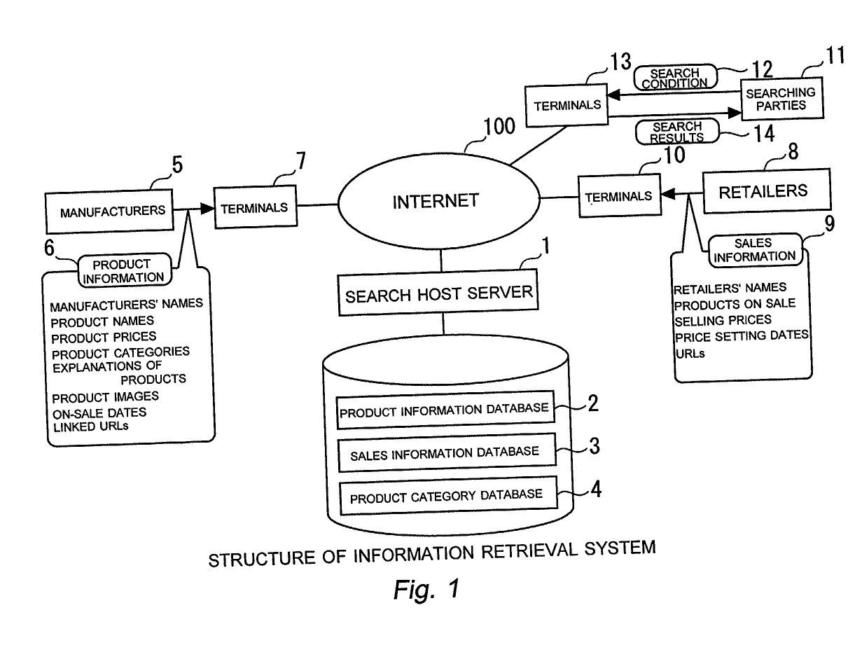

FIG. 1 is a schematic view showing a typical structure of a product information retrieval system practiced as a common basis for the different embodiments of this invention. This product information retrieval system interconnects, as shown in FIG. 1, a search host server 1 (product information providing terminal) offering product information to searching parties 11, terminals 13 of the searching parties 11 (product information requesting terminals) asking the search host server 1 for product information, terminals 7 of manufacturers 5, and terminals 10 of retailers 8 via a network (the Internet 100 in this case).

The searching parties 11 send search conditions 12 from their terminals 13 to the search host server 1 over the Internet 100. The search host server 1 returns search results 14 to the searching parties 11. The manufacturers 5 transmit product information 6 such as manufacturer names and product names from their terminals 7 to the search host server 1 over the Internet 100. The retailers 8 send sales information 9 such as retailer names and products on sale from the terminals 10 to the search host server 1 over the Internet 100.

Given the product information 6 and sales information 9 thus transmitted, the search host server 1 builds and manages a product information database 2, a sales information database 3 and a product category database 4.

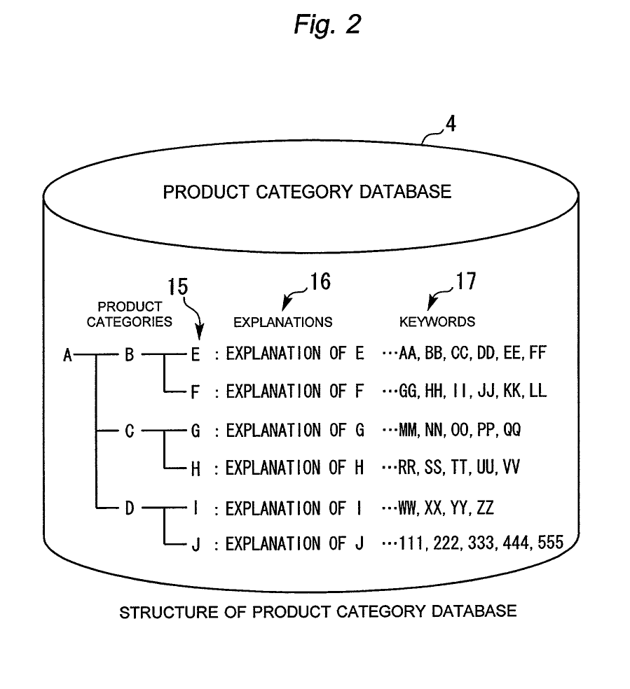

FIGS. 2, 3 and 4 are schematic views illustrating typical structures of the product category database 4, product information database 2 and sales information database 3 respectively which are managed by the search host server 1.

As depicted in FIG. 2, the product category database 4 manages product categories 15 (E-J) using a directory structure. Each of the categories 15 is associated with an explanation 16 and keywords 17.

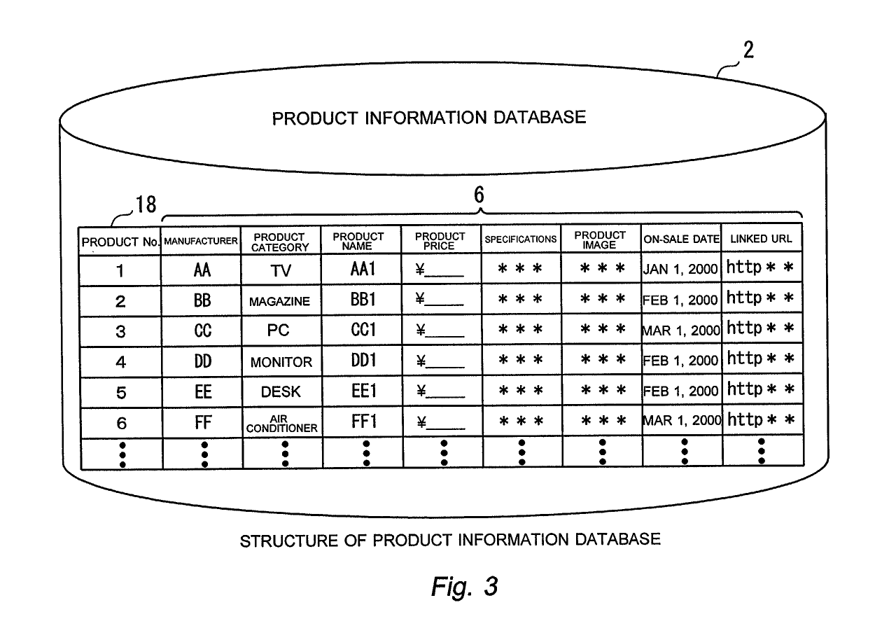

As indicated in FIG. 3, the product information database 2 comprises product information 6 acquired from the manufacturers 5 through their terminals 7 and associated with product numbers 18 for product identification and product information management purposes. The product information 6 is constituted by manufacturer names, product categories (corresponding to the product categories 15 in the product category database 4), product names, product prices, product specifications, product image data, on-sale dates, and URLs linked to the individual manufacturers 5.

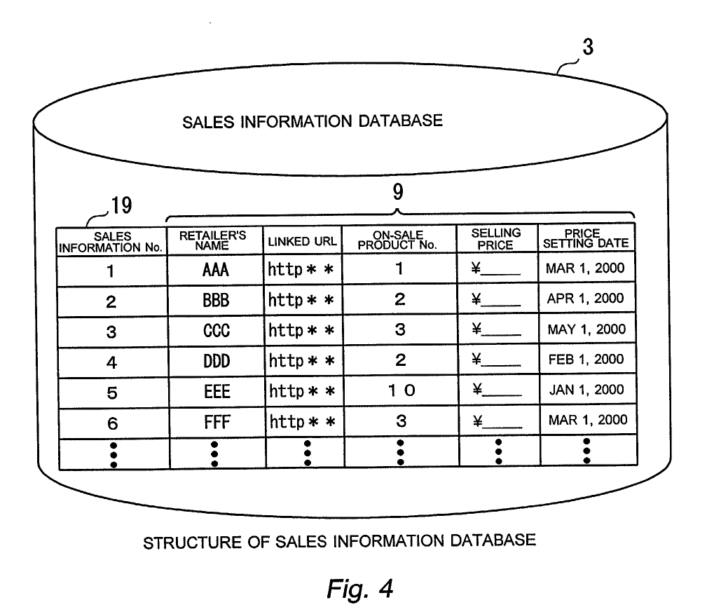

As shown in FIG. 4, the sales information database 3 comprises sales information 9 obtained from the retailers 8 and associated with sales information numbers 19 for sales identification and sales information management purposes. The sales information 9 is constituted by retailer names, URLs linked to the individual retailers, on-sale product numbers (corresponding to the product numbers 18 managed by the product information database 2), selling prices, and price setting dates.

As described, the search host server 1 establishes automatically the product information database 2, sales information database 3, and product category database 4 by use of product-related information that has been received. As such, the server 1 can provide the searching parties 11 with detailed information relevant to the search conditions 12 received from the parties 11. In particular, receiving the product information 6 and sales information 9 from a plurality of manufacturers 5 and retailers 8 allows the search host server 1 to boost the quantities of information in the product information database 2 and sales information database 3. The growing volumes of accumulated information in the databases enable the server to better provide information meeting the requirements of the searching parties 11.

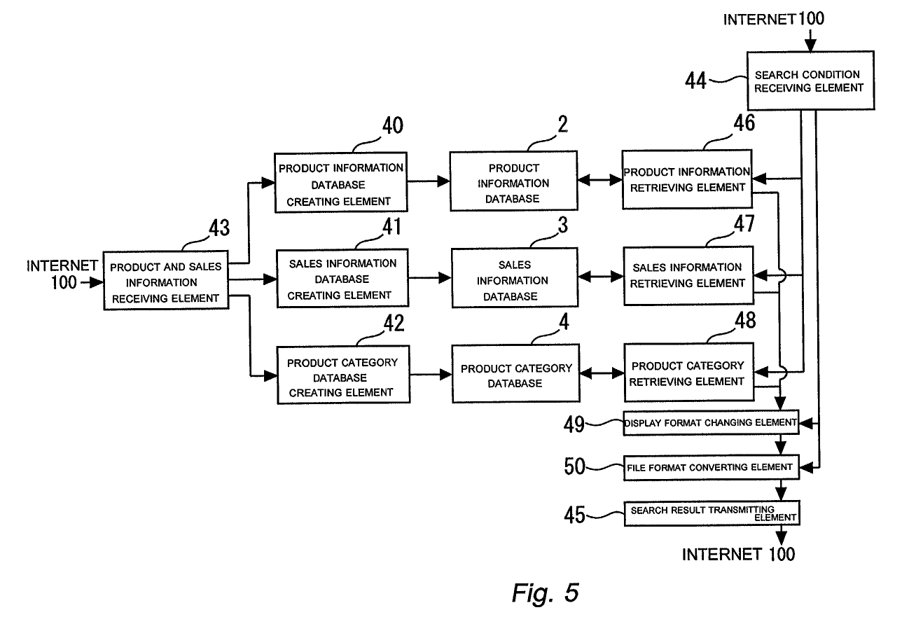

FIG. 5 is a block diagram of the search host server 1. As shown in FIG. 5, the search host server 1 has three database creating elements: a product information database creating element 40 for creating the product information database 2 using the product information 6; a sales information database creating element 41 for creating the sales information database 3 using the sales information 9 sent by the retailers 8, and a product category database creating element 42 for creating the product category database 4 using the product information 6 and other related information. The product information 6 and sales information 9 are received by a product and sales information receiving element 43 and forwarded to the product information database creating element 40, sales information database creating element 41 and product category database creating element 42.

In creating the databases 2, 3 and 4, those who wish to advertise their products such as the manufacturers 5 and retailers 8 register in the search host server 1 their advertisements illustratively in the form of product information 6 and sales information 9. The registered advertisements are used as a basis for creating the databases 2, 3 and 4. This makes it possible for the manufacturers 5 and retailers 8 to let only the desired information about their products be searched for and retrieved; there is no fear of any undesired items of information getting retrieved by prying parties. The databases 2, 3 and 4 may offer storage areas that are updated whenever desired. Such areas, if used by the manufacturers 5 and retailers 8, will allow them to offer their advertisements in real time to the searching parties 11.

The search host server 1 also includes: a search condition receiving element 44 for receiving search conditions 12 from the terminals 13 of the searching parties 11; a search result transmitting element 45 for transmitting search results 14; a display format changing element 49 for changing display formats by sorting and filtering the search results 14 as requested by the searching parties 11; and a file format converting element 50 for converting file formats of data sent to the terminals 13 as requested by the searching parties 11.

The search host server 1 further comprises: a product retrieving element 46 for retrieving from the product information database 2 product numbers 18 applicable to the received search condition 12; a sales information number retrieving element 47 for retrieving from the sales information database 3 sales information numbers 19 applicable to the received search condition 12; and a product category retrieving element 48 for retrieving from the product category database 4 product categories 15 applicable to the received search condition 12.

The databases 2, 3 and 4 may be either included in the search host server 1 as shown in FIG. 5, or constituted by a storage device or devices independent of the server 1.

A search condition 12 sent by a searching party 11 over the Internet 100 is received by the search condition receiving element 44 and analyzed thereby. Depending on the analyzed content of the search condition 12, the product retrieving element 46, product category retrieving element 48 and sales information number retrieving element 47 retrieve a product number 18, a product category 15 and a sales information number 19 respectively. The retrieved information is transmitted by the search result transmitting element 45.

What follows is a description of how product-related information is illustratively retrieved by use of the above-described product information retrieval system embodying the invention. The first embodiment of this invention involves retrieving from the product information database 2 a product number 18 corresponding to a search condition 12 from a searching party 11.

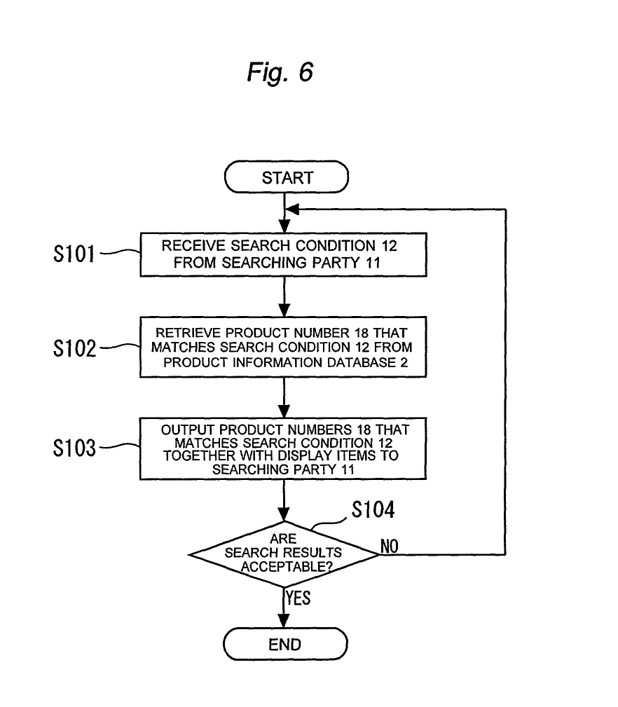

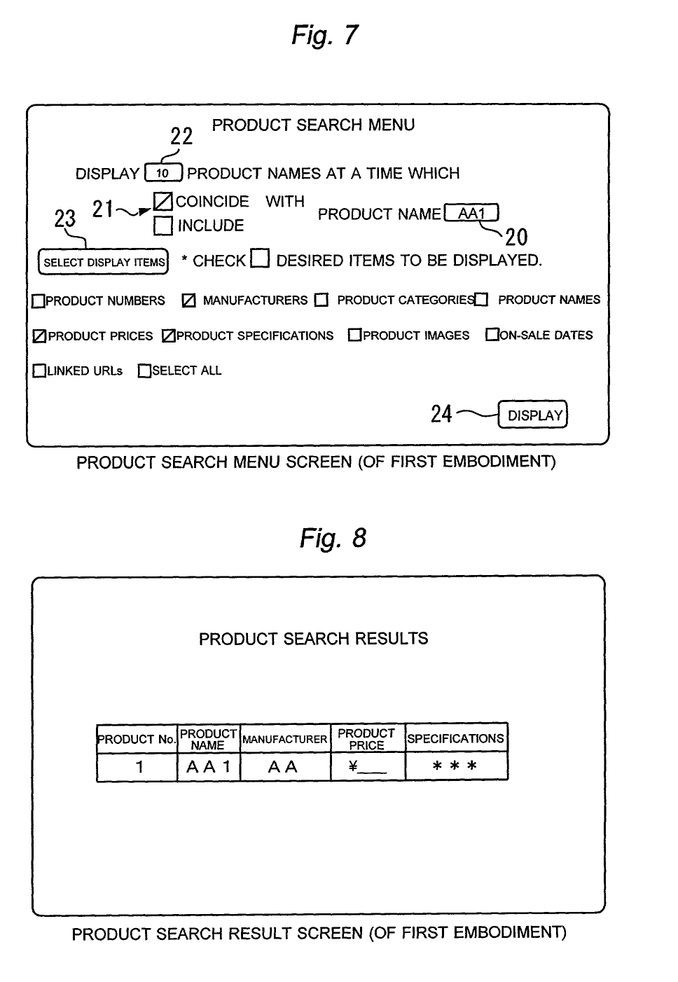

Described below with reference to FIGS. 6, 7 and 8 is how the search host server 1 works when the searching party 11 carries out a search for the manufacturer, price and specifications of a product named “AA1.” In step S101 of FIG. 6, the search host server 1 causes the product search menu screen of FIG. 7 to appear on the terminal 13 of the searching party 11, and prompts the party 11 to input the search condition 12 including a display condition. More specifically, as shown in FIG. 7, a product name “AA1” is input to a product name input field 20. An option “product that matches a keyword” is checked in a matching condition input field 21. A display increment count of, say, 10 is input to a display count input field 22. In a display item selection field 23, items “manufacturers,” “product prices” and “product specifications” are checked. The items and options thus picked make up the search condition 12. The searching party 11 sends the prepared search condition 12 to the search host server 1 by clicking a search execution button 24 in the bottom right corner of the screen.

Upon receipt of the search condition 12, the search host server 1 searches the product information database 2 in step S102 for product names that match the name “AA1.” In this example, the server 1 retrieves product numbers 18 corresponding to the search condition 12.

In step S103, as shown in FIG. 8, the search host server 1 transmits the retrieved product numbers 18 along with associated information corresponding product numbers 18 to the terminal 13 as search results 14. At this point, the server 1 outputs the first 10 product names in descending order of their product numbers 18 to the terminal 13 for display on a monitor. The terminal 13 gives its display in accordance with the display condition that was sent earlier by the searching party 11 using the menu screen of FIG. 7. Because the items “manufacturers,” “product prices” and “product specifications” have been checked in the display item selection field 23, data applicable to these items are displayed as the search results 14 as shown in FIG. 8.

In the example of FIG. 8, only one product applies to the search condition and thus the single product number 18 is displayed. If a plurality of products match the condition, these will be displayed in descending order of their product numbers 18. If more than 10 products are matched, they will be displayed in increments of 10 in accordance with the display increment count of 10 set in the display count input field 22 of the menu screen in FIG. 7.

In step S104, the search host server 1 receives from the searching party 11 information as to whether the search results 14 are deemed satisfactory. If the results are reported satisfactory, the processing is terminated. If the search results 14 are not judged satisfactory, step S101 is reached again and the search host server 1 prompts the searching party 11 to input another search condition 12.

With the first embodiment, as described, the search host server 1 builds automatically the product information database 2 based on the product information 6 provided by the manufacturers 5. Given the search condition 12 from the searching party 11, the server 1 retrieves the applicable product information from the product information database 2. This eliminates the need for the searching party 11 to find the websites (URLs) of the manufacturers 5 and check the sites individually for product information. The search host server 1 allows the searching party 11 to search for and retrieve necessary product information accurately and quickly.

Second Embodiment

The second embodiment of this invention will now be described. The second embodiment involves searching for products that fall under the product categories 15 registered in the product category database 4 as part of the product information retrieval system discussed above in connection with the first embodiment.

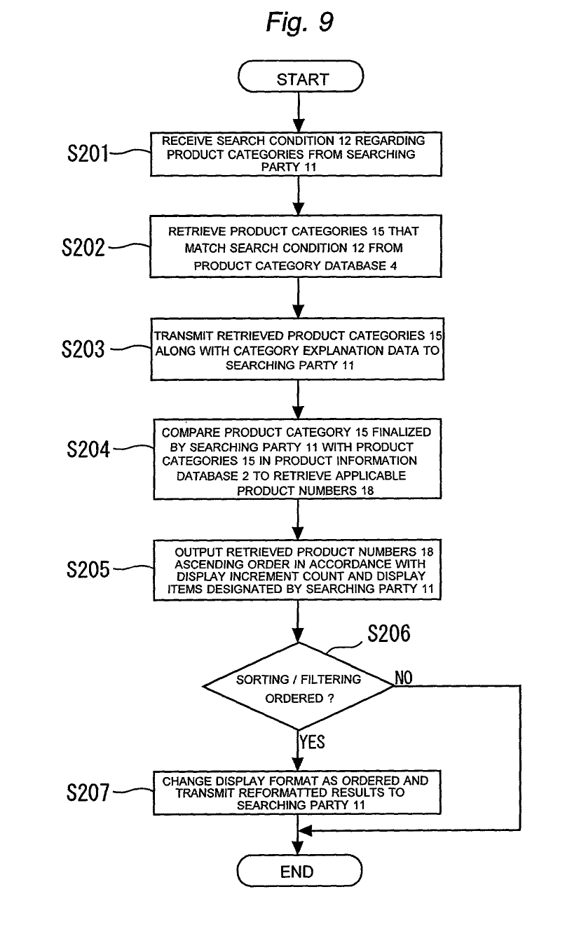

Described below with reference to FIGS. 9 through 15 is how the search host server 1 works when a searching party 11 searches for and compares information about manufacturers, prices and product specifications of, say, “liquid crystal display television sets marketed since January 1, 2000.”

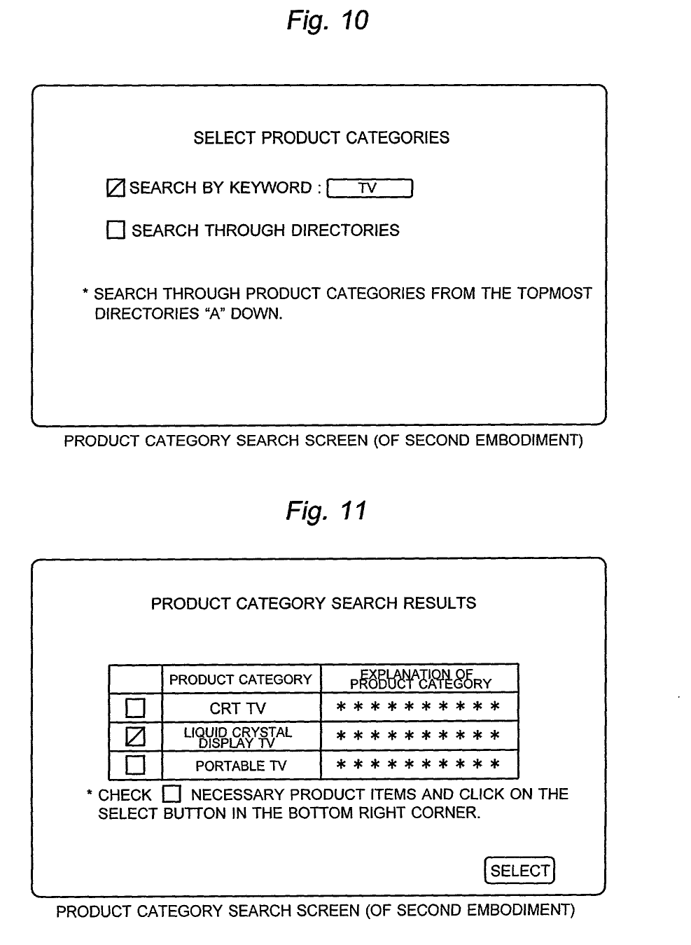

In step S201 of FIG. 9, the search host server 1 causes the product category search screen of FIG. 10 to be displayed so that the party 11 may select a product category on the screen. The selected product category constitutes a search condition 12.

The product category 15 is selected by one of two methods: (1) by input of a keyword, or (2) by selection of a directory.

The method (1) above involves the search host server 1 comparing a keyword entered into the search screen of FIG. 10 with the data in the product category database 4 (i.e., product categories 15, explanations 16, keywords 17) so as to select applicable product categories 15 (those from E through J). The method (2) involves allowing the searching party 11 to search through the product categories 15 (E through j) from the topmost directory A down before deciding on a suitable product category 15.

In this example, the method (1) is adopted for the search. Step S201 is followed by step S202 in which the search host server 1 compares a keyword “TV” input to the screen of FIG. 10 with the data (product categories 15, explanations 16, keywords 17) in the product category database 4 in FIG. 2. Through the comparison, the search host server 1 retrieves data representing the product categories 15 and explanations 16 matching the keyword “TV”. The keyword “TV” is compared mainly with the keywords 17 in the product category database 4. In step S203, the search results 14 are presented to the searching party 11 on the display screen of FIG. 11. In this example, product categories “CRT TV,” “liquid crystal display TV” and “portable TV” retrieved as the matched product categories 15 are sent to the terminal 13 as the search results 14 together with the related explanations 16. Thereafter, the searching party 11 refers to the output results of FIG. 11 and decides illustratively on the category of “liquid crystal display TV”.

In step S204, the search host server 1 compares the selected product category “liquid crystal display TV” with the product categories 15 in the product information database 2. In the event of a category match, the server 1 retrieves product numbers 18 that fall under the matched category.

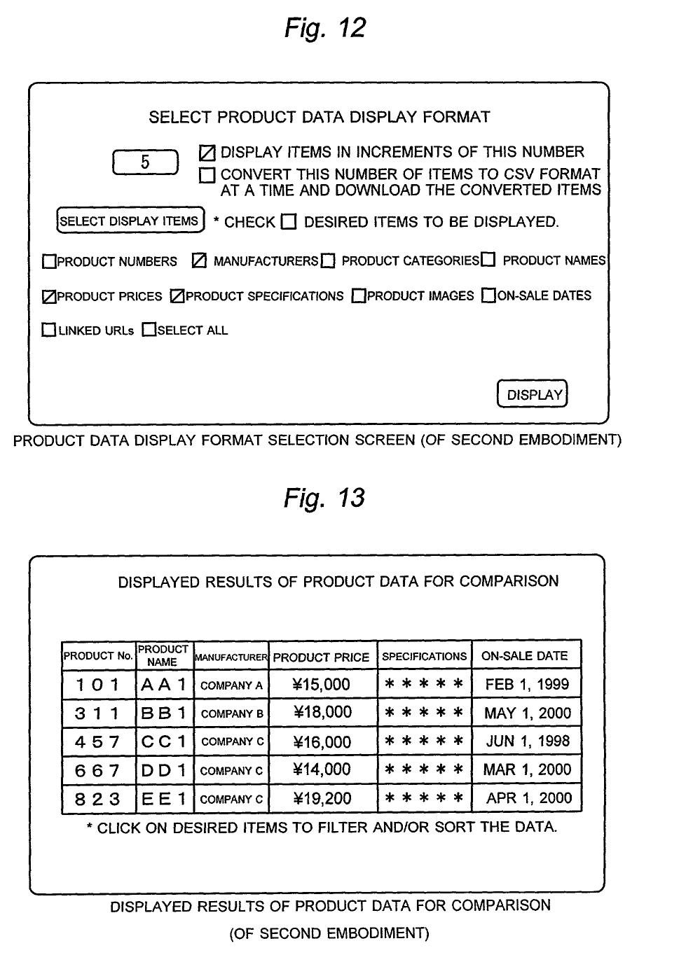

In step S205, the search host server 1 outputs the product numbers 18 in ascending order as shown in FIG. 13 after their retrieval based on the search condition 12 (display increment count (5 items), display items (manufacturers, prices, product specifications, on-sale dates)) determined by the searching party 11 on the product data display format selection screen of FIG. 12. This allows the searching party 11 to acquire the definitive search results 14.

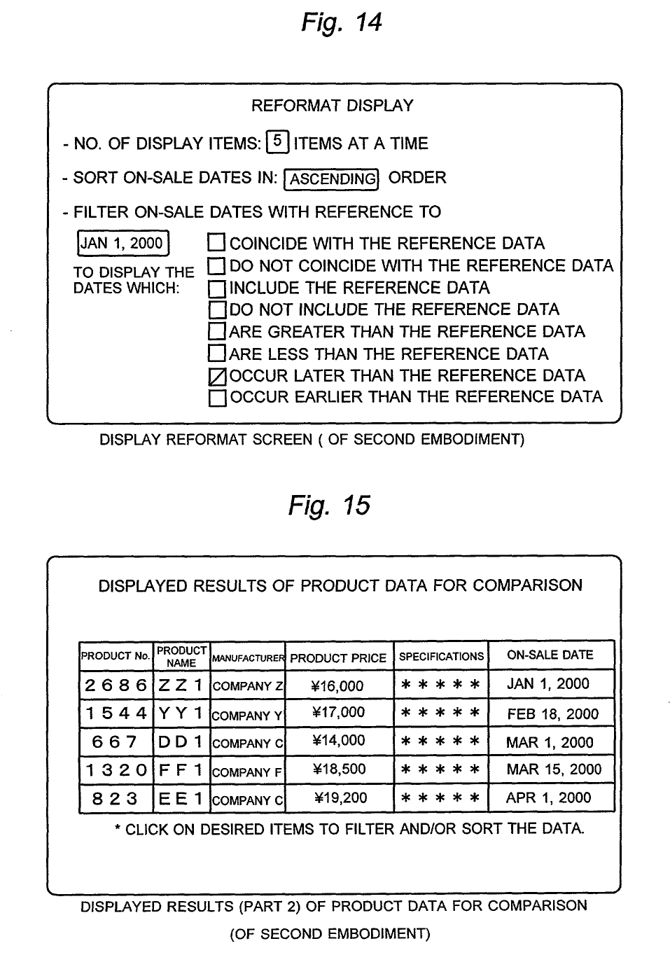

The search host server 1 is capable of sorting and filtering the data retrieved from the product information database 2 in response to the request by the searching party 11. Thus in step S206, the server 1 judges whether the searching party 11 has clicked on any of the display items on the display screen of FIG. 13. If the searching party 11 is judged to have clicked on some display items on the display screen of FIG. 13, the search host server 1 proceeds with a reformatting process using the display reformat screen of FIG. 14. The reformatting allows the search results 14 to be sorted and filtered as desired. The sorting and filtering processes are performed by the display format changing element 49 shown in FIG. 5.

Suppose that the searching party 11 clicks on the display item “on-sale dates” on the screen of FIG. 13, enters a display increment count of 5 in the screen of FIG. 14, selects “ascending order” for sorting, and designates on-sale dates “since January 1, 2001” for filtering. In that case, the search host server 1 goes to step S207 and reformats the search results 14 in FIG. 13 as shown in FIG. 15 before sending the results to the searching party 11. In FIG. 15, as the search result, the order of the product numbers 18 are rearranged in ascending order of the on-sale date of the products. If no order is given in step S206 for sorting or filtering, the processing is terminated.

With the second embodiment, as described, the search host server 1 builds the product category database 4 and product information database 2 using the product information 6 provided by the manufacturers 5, determines a product category from the product category database 4 in accordance with the search condition 12 from the searching party 11, and retrieves information about products that fall under the determined product category. This eliminates the need for the searching party 11 to find the websites (URLs) of the manufacturers 5 and check the sites individually for product information; the server 1 allows the searching party 11 to focus on products by product category and thereby obtain and compare necessary product information easily. The search host server's ability to focus on, sort and filter data allows the searching parties 11 to acquire the results 14 with ease according to desired conditions, which boosts the efficiency of searching for and retrieving product information.

Third Embodiment

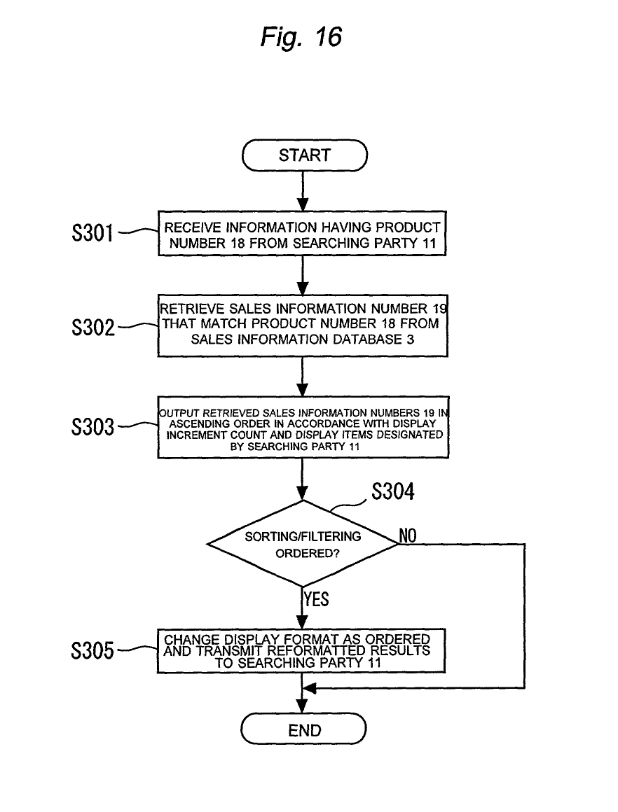

The third embodiment of this invention will now be described. The third embodiment involves searching for the names of retailers selling a product named “AA1” (with a product number “1”) as well as selling prices of the product at these retailers. The product name is acquired by the product information retrieval system discussed in connection with the first embodiment. The retailers are displayed in ascending order of their selling prices set for the product in question. How the search host server 1 executes such functions is described below by referring to FIGS. 16 through 19.

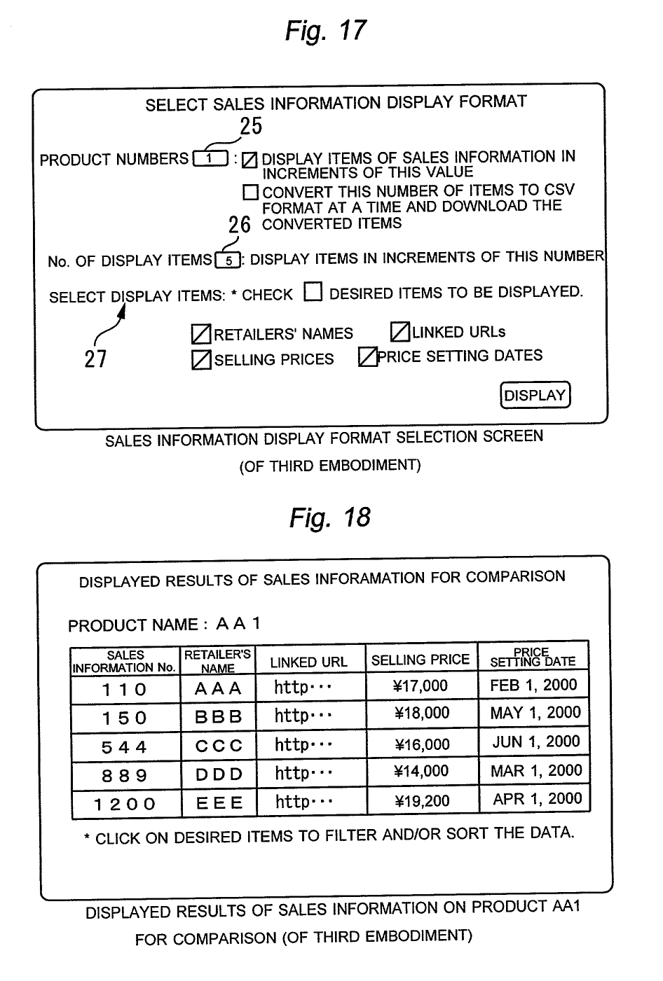

In step S301 of FIG. 16, the search host server 1 receives from the searching party 11 a product number 18 of the product to be searched for in connection with retailers. The server 1 sends the sales data display format selection screen of FIG. 17 to the terminal 13 of the searching party 11, and prompts the party 11 to make an entry into a product number input field 25. The search host server 1 in this example is informed that the product number 18 of the product in question is “1”. At the same time, the server 1 prompts the searching party 11 to make necessary entries into a display count input field 26 and a display item selection field 27 (retailer names, linked URLs, selling prices, price setting dates) constituting a search condition 12.

In step S302, the search host server 1 retrieves from the sales information database 3 sales information numbers 19 of the retailers that sell the product having the product number of 1.

In step S303, the search host server 1 outputs to the searching party 11 the search results 14 of FIG. 18 composed of the retrieved sales information numbers 19 together with data applicable to the items selected in the display item selection field 27 on the selection screen of FIG. 17. Because the display increment count of 5 has been input in the display count input field 26 on the selection screen of FIG. 17, the sales information numbers 19 are displayed in increments of five in ascending order as shown in FIG. 18.

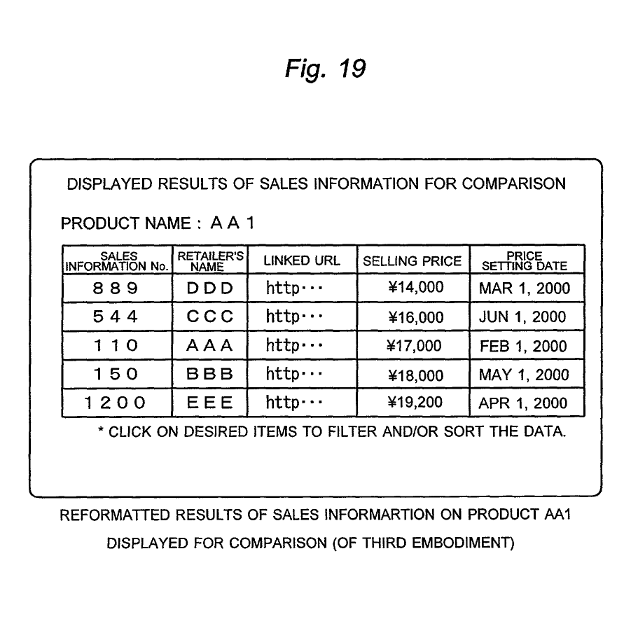

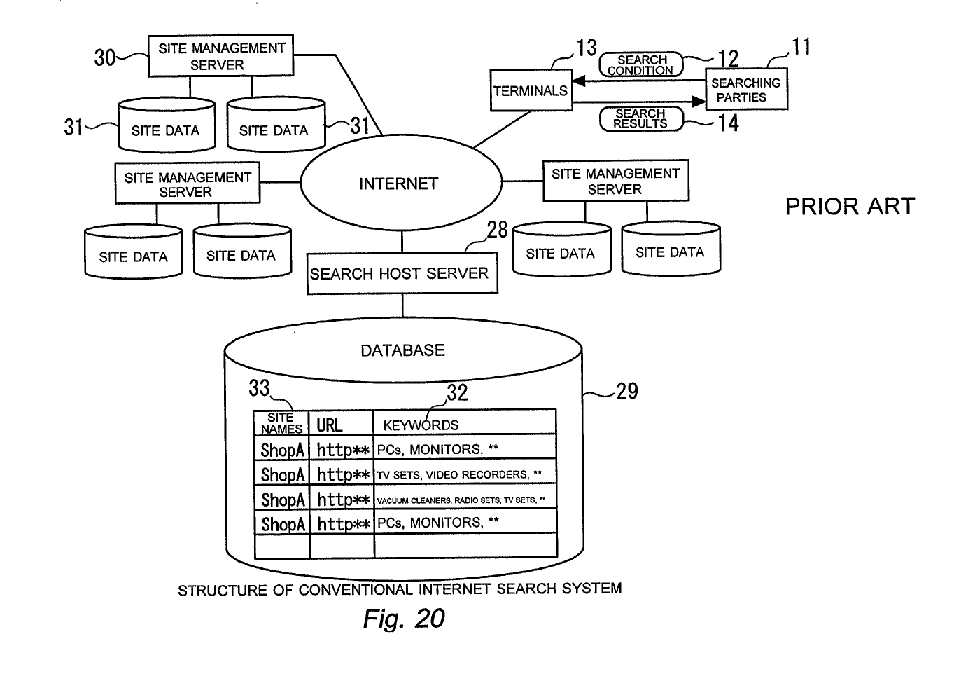

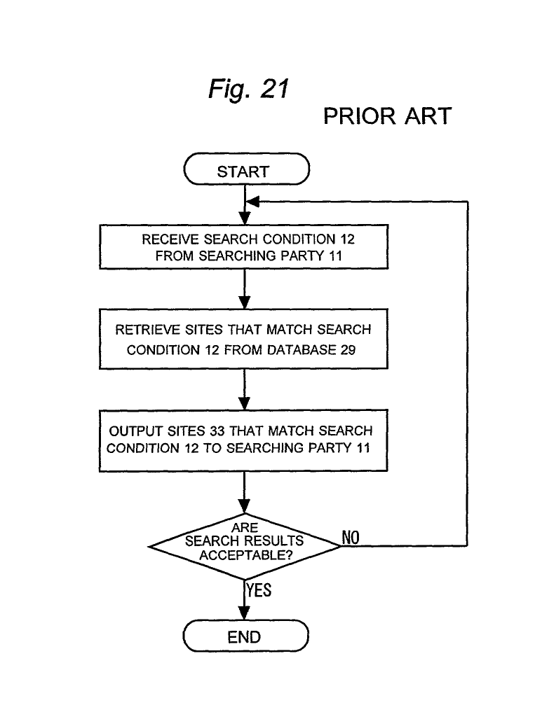

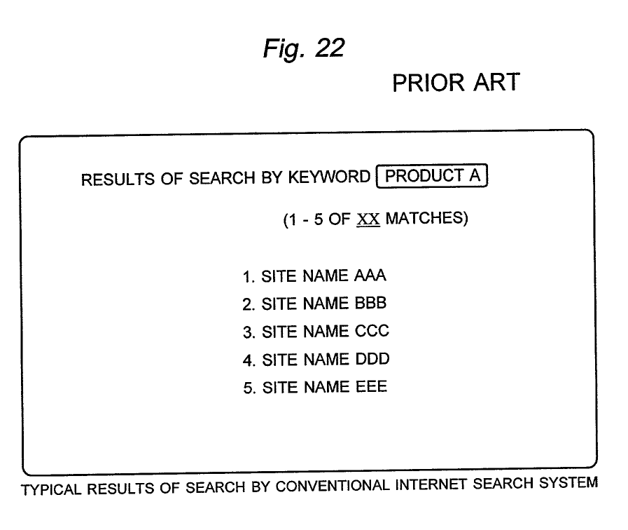

With the third embodiment of the invention, as with the second embodiment, the search host server 1 is capable of filtering and sorting the search results 14. If an order is given in step S304 for sorting and/or filtering, step S305 is reached in which the sorting and/or filtering process is carried out. Illustratively, the search results 14 of FIG. 18 may be rearranged by price into what is shown in FIG. 19 before being sent to the searching party 11.

As described, the third embodiment causes the search host server 1 to build the sales information database 3 using the sales information 9 from the retailers 8. Given the search condition 12 from the searching party 11, the search host server 1 retrieves relevant retailer information from the sales information database 4. This eliminates the need for the searching party 11 to find the websites (URLs) of the retailers 8 selling the desired products and check the sites individually for product prices; the searching party 11 is allowed to obtain sales information on desired products in a desired data format, which significantly increases the efficiency of searching for and retrieving product sales information over the Internet 100. The retailers 8, for their part, are enabled to offer pertinent information to the searching parties 11 requesting product information, whereby advertising efficiency is boosted.

Fourth Embodiment

The fourth embodiment of this invention will now be described. The fourth embodiment involves having search results 14 converted to a suitable data format and getting the converted data sent to a searching party 11 through the use of the product information retrieval system discussed above in connection with the first embodiment.

With the fourth embodiment, the search host server 1 converts to CSV format (i.e., text files delimited by commas) the search results 14 to be output to the searching party 11 by the second or the third embodiment, and sends the converted results to the terminal 13 of the searching party 11 over the Internet 100. When wishing to convert the search results 14 derived from the second embodiment, the searching party 11 picks the option “convert to CSV format and download” in a product data display format selection field on the selection screen of FIG. 12. Given the pick, the search host server 1 does not immediately output the search results 14 from the product information database 2 onto the monitor but converts them into CSV format before sending them to the terminal 13 of the searching party 11 over the Internet 100. The file format conversion is performed by the file format converting element 50 shown in FIG. 5.

With the fourth embodiment of this invention, as with the third embodiment, when the searching party 11 picks the option “convert to CSV format and download” in the sales information display format selection screen on the selection screen of FIG. 17, the search host server 1 converts the search results 14 to CSV format before transmitting them to the party 11. Given the transmission of the search results 14 in CSV format, the searching party 11 processes the results as desired for use in an application program capable of handling CSV files so that more detailed searches may be carried out.

With the fourth embodiment, as described, the search host server 1 sends the search results 14 in CSV format to the searching party 11. In turn, the party 11 may treat the received results as needed for use in an application program. This enhances the degree of freedom in carrying out more detailed searches. When the search results 14 in CSV format are held on a storage device of the searching party 11, network loads are alleviated at the time of searches so that the time required for maintaining connection to the Internet may be shortened.

Although the fourth embodiment has been described as handling the CSV format as a download file format, this is not limitative of the invention. Other suitable file formats may be selected and utilized as desired by the searching party 11.

It is also possible for the first embodiment to convert data formats for transmission using the file format converting element 50. Given a request from the searching party 11, the first embodiment may also change the display format by use of the display format changing element 49 before sending the converted results to the terminal 13.

Blocks and steps for implementing the functions discussed above in connection with the embodiments may be provided by hardware of the search host server 1. A microcomputer system, not shown, made up of a CPU or an MPU, a ROM, a RAM and other components as part of the search host server 1 may constitute the necessary function blocks and processing steps operated by work programs held in the ROM or RAM. Alternatively, the work programs may be retained by a suitable entity independent of the search host server 1, and that entity may be attached upon use to a mounting portion of the server 1 to carry out the necessary operations.

The invention also envisages getting a RAM of the search host server 1 to retain software programs representative of the necessary functions in blocks described above; the function blocks may then be implemented by running the programs. In that case, the programs themselves are arranged so as to implement the relevant functions discussed above. These programs may be held by suitable means for supplying the computer system in use with the programs. The means such as a program storage medium also constitutes this invention.

As described, one embodiment of the invention involves creating a product information database by use of received product information and allowing information on relevant products to be retrieved from the database in accordance with a search condition received from a product information requesting terminal. This eliminates the need for any searching party to find the websites (URLs) of manufacturers and check the sites individually for product information. The embodiment allows the searching party to search for the necessary product information quickly and accurately.

In a preferred structure of the invention, the product information database may be made up of product information received from a plurality of manufacturers. The increased amount of information in the product information database makes it possible to offer product information that is better suited for the searching party's requirements.

In another preferred structure of the invention, given a search condition from the product information requesting terminal, applicable product categories may be retrieved from a product category database which classifies products by category. The searching party is allowed to focus on products by product category and thus compare the necessary product information easily.

In a further preferred structure of the invention, a sales information database may be created by use of received sales information and, given a search condition from the product information requesting terminal, relevant retailer information may be retrieved from the database. This eliminates the need for the searching party to find the websites of the retailers and check the sites individually for product prices. The searching party is allowed to obtain sales information on desired products in a desired data format.

In an even further preferred structure of the invention, the sales information database may be made up of sales information received from a plurality of retailers. The increased amount of information in the sales information database makes it possible to offer retailer information that is better suited for the searching party's requirements.

In a still further preferred structure of the invention, the product information database may be created by attaching a product number to each of the products on the basis of the product information, and desired production information may be retrieved by product number in accordance with the search condition. This allows more detailed searches to be carried out easily based on the search results including product numbers.

In a yet further preferred structure of the invention, display contents of the search results may be reformatted as requested by the product information requesting terminal. This allows the searching party to obtain the search results in a desired display format.

In another preferred structure of the invention, the product category database may be created by classifying the product information in a directory structure. This permits searches for product information by the category entered as a search condition.

In a further preferred structure of the invention, the sales information database may be created by attaching a sales information number to each of the retailers on the basis of the sales information and, given a search condition, relevant sales information may be retrieved by the sales information number from the database. This makes it possible to perform more detailed searches based on the search results involving sales information numbers.

In another preferred variation of the invention, search results may be converted to a file format such as CSV format as requested by the product information requesting terminal before the converted data are transmitted to the requesting terminal. This allows the searching party to process the search results as needed for use in a desired application program. The searching party is also given an enhanced degree of freedom in carrying out more detailed searches. When the search results are retained in CSV format on the searching party's storage device, network loads are alleviated at the time of searches so that the time required for maintaining connection to the Internet may be shortened.

As described and according to the invention, product-related information is searched for and retrieved in a highly efficient manner over the Internet. Manufacturers and retailers may provide searching parties with pertinent product and sales information efficiently by use of embodiments of this invention.

Beside the claimed invention, the present invention includes various aspects as described above and summarized as follows.

According to one aspect of the present invention, a product information providing method for use with a product information retrieval system comprising a product information providing terminal and a product information requesting terminal connected via a network. The method comprises the following steps. Firstly the product information providing terminal is allowed to receive a search condition regarding retailers. Secondly the product information providing terminal is allowed to retrieve information on the retailers applicable to the search condition from a sales information database made up of information from a plurality of retailers. Thirdly the product information providing terminal is allowed to transmit the retrieved retailer information to the product information requesting terminal.

According to another aspect of the present invention, the sales information database has the sales information managed by attaching a sales information number to each of the retailers. The second step includes causing the retailer information to be retrieved by sales information number in accordance with the search condition.

According to another aspect of the present invention, the method further comprises the fourth step, following the third step, of allowing the product information providing terminal to receive a request from the product information requesting terminal requiring a change of a display format of the retrieved retailer information, and the fifth step, based on the request, of allowing the product information providing terminal to change the display format of the retailer information before sending the reformatted information to the product information requesting terminal.

According to another aspect of the present invention, a product information providing method for use with a product information retrieval system comprising a product information providing terminal and a product information requesting terminal connected via a network. The method comprises the following steps. Firstly the product information providing terminal is allowed to receive a search condition regarding products. Secondly the product information providing terminal is allowed to retrieve categories of the products applicable to the search condition from a product category database having products classified by category. Thirdly the product information providing terminal is allowed to transmit the retrieved product categories to the product information requesting terminal.

According to another aspect of the present invention, the method further comprises the fourth step, following the third step, of allowing the product information providing terminal to retrieve information on the products applicable to the retrieved categories from a product information database made up of product information from a plurality of manufacturers, and the fifth step of allowing the product information providing terminal to transmit the retrieved product information to the product information requesting terminal.

According to another aspect of the present invention, the method further comprises the sixth step, following the fifth step, of allowing the product information providing terminal to receive a request from the product information requesting terminal requiring a change of a display format of the retrieved product information, and the seventh step, based on the request, of allowing the product information providing terminal to change the display format of the product information before sending the reformatted information to the product information requesting terminal.

According to another aspect of the present invention, the third step includes allowing the product information providing terminal to convert the information to be transmitted into CSV format before sending the converted information to the product information requesting terminal.

According to another aspect of the present invention, a computer-readable storage medium which stores a program for causing a computer to implement the means constituting the product information providing terminal equipment.

According to another aspect of the present invention, a computer-readable storage medium which stores a program for causing a computer to implement the steps constituting the product information providing method.

According to another aspect of the present invention, a program for operating a computer comprises product information database creating means for creating a product information database using received product information, product information retrieving means for retrieving information on applicable products from the product information database in accordance with a received search condition, and product information transmitting means for transmitting the retrieved product information.

According to another aspect of the present invention, a program for operating a computer comprises sales information database creating means for creating a sales information database using sales information received from retailers, sales information retrieving means which, in accordance with a received search condition, retrieves information on applicable retailers from the sales information database, and retailer information transmitting means for transmitting the retrieved retailer information.

According to another aspect of the present invention, for use with a product information retrieval system comprising a product information providing terminal and a product information requesting terminal connected via a network, a program for causing a computer of the system to implement the following steps. Firstly the product information providing terminal is allowed to receive a search condition regarding products. Secondly the product information providing terminal is allowing to retrieve information on the products applicable to the search condition from a product information database made up of product information from a plurality of manufacturers. Thirdly the product information providing terminal is allowed to transmit the retrieved product information to the product information requesting terminal.

According to another aspect of the present invention, for use with a product information retrieval system comprising a product information providing terminal and a product information requesting terminal connected via a network, a program for causing a computer of the system to implement the following steps. Firstly the product information providing terminal is allowed to receive a search condition regarding retailers. Secondly the product information providing terminal is allowed to retrieve information on the retailers applicable to the search condition from a sales information database made up of information from a plurality of retailers. Thirdly the product information providing terminal is allowed to transmit the retrieved retailer information to the product information requesting terminal.

According to another aspect of the present invention, for use with a product information retrieval system comprising a product information providing terminal and a product information requesting terminal connected via a network, a program for causing a computer of the system to implement the following steps. Firstly the product information providing terminal is allowed to receive a search condition regarding products. Secondly the product information providing terminal is allowed to retrieve categories of the products applicable to the search condition from a product category database having products classified by category. Thirdly the product information providing terminal is allowed to transmit the retrieved product categories to the product information requesting terminal.

Obviously many modifications and variations of the present invention are possible in the light of the above teachings. It is therefore to be understood that within the scope of the appended claims the invention may by practiced otherwise than as specifically described.

The entire disclosure of a Japanese Patent Application No. 2001-100874, filed on Mar. 30, 2001 including specification, claims, drawings and summary, on which the Convention priority of the present application is based, are incorporated herein by reference in its entirety.

1. A product information retrieval system comprising a product information providing terminal and a product information requesting terminal connected via a network;
wherein said product information providing terminal includes:
product information database creating means for creating a product information database using received product information;
product information retrieving means for retrieving information on applicable products from said product information database in accordance with a search condition received from said product information requesting terminal; and
product information transmitting means for transmitting the retrieved product information to said product information requesting terminal.

2. A product information retrieval system according to claim 1, wherein said product information database creating means creates said product information database using said product information received from a plurality of manufacturers.

3. A product information retrieval system according to claim 1, wherein said product information providing terminal further comprises:
product category retrieving means which, in accordance with a search condition received from said product information requesting terminal, retrieves applicable product categories from a product category database which classifies products by category; and
product category transmitting means for transmitting the retrieved product categories to said product information requesting terminal.

4. A product information retrieval system according to claim 1, wherein said product information providing terminal further comprises:
sales information database creating means for creating a sales information database using sales information received from retailers;
sales information retrieving means which, in accordance with a search condition received from said product information requesting terminal, retrieves information on applicable retailers from said sales information database; and
retailer information transmitting means for transmitting the retrieved retailer information to said product information requesting terminal.

5. A product information retrieval system according to claim 4, wherein said sales information database creating means creates said sales information database using said sales information received from a plurality of retailers.

6. Product information providing terminal equipment connected to a product information requesting terminal via a network, the providing terminal equipment comprising:
product information database creating means for creating a product information database using received product information;
product information retrieving means which, in accordance with a search condition received from said product information requesting terminal, retrieves information on applicable products from said product information database; and
product information transmitting means for transmitting the retrieved product information to said product information requesting terminal.

7. Product information providing terminal equipment according to claim 6, wherein said product information database creating means creates said product information database using said product information received from a plurality of manufacturers.

8. Product information providing terminal equipment according to claim 6, wherein said product information database creating means creates said product information database by attaching a product number to each of the products on the basis of said product information; and
wherein said product information retrieving means retrieves said product information by each product number in accordance with said search condition.

9. Product information providing terminal equipment according to claim 6, further comprising display format changing means for reformatting display contents of said retrieved product information as requested by said product information requesting terminal.

10. Product information providing terminal equipment according to claim 6, further comprising:
product category retrieving means which, in accordance with a search condition received from said product information requesting terminal, retrieves applicable product categories from a product category database which classifies products by category; and
product category transmitting means for transmitting the retrieved product categories to said product information requesting terminal.

11. Product information providing terminal equipment according to claim 10, further comprising product category database creating means for creating said product category database by classifying said product information in a directory structure.

12. Product information providing terminal equipment according to claim 6, further comprising:
sales information database creating means for creating a sales information database using sales information received from retailers;
sales information retrieving means which, in accordance with a search condition received from said product information requesting terminal, retrieves information on applicable retailers from said sales information database; and
retailer information transmitting means for transmitting the retrieved retailer information to said product information requesting terminal.

13. Product information providing terminal equipment according to claim 12, wherein said sales information database creating means creates said sales information database using said sales information received from a plurality of retailers.

14. Product information providing terminal equipment according to claim 12, wherein said sales information database creating means creates said sales information database by attaching a sales information number to each of the retailers on the basis of said sales information; and
wherein said sales information retrieving means retrieves said retailer information by each sales information number in accordance with said search condition.

15. Product information providing terminal equipment according to claim 12, further comprising display format changing means for reformatting display contents of said retrieved retailer information as requested by said product information requesting terminal.

16. Product information providing terminal equipment according to claim 6, further comprising file format converting means for converting a file format of data to be transmitted to said product information requesting terminal as designated by said requesting terminal.

17. A product information providing method for use with a product information retrieval system comprising a product information providing terminal and a product information requesting terminal connected via a network, the method comprising:
the first step of allowing said product information providing terminal to receive a search condition regarding products;
the second step of allowing said product information providing terminal to retrieve information on the products applicable to said search condition from a product information database made up of product information from a plurality of manufacturers; and
the third step of allowing said product information providing terminal to transmit the retrieved product information to said product information requesting terminal.

18. A product information providing method according to claim 17, wherein said product information database has said product information managed by attaching a product number to each of the products; and
wherein said second step includes causing the product information to be retrieved by said product number in accordance with said search condition.
